(19) United States
(12) Patent Application Publication
(10) Pub. No.: US 2026/0276539 A1
(43) Pub. Date: Sep. 17, 2026

(54) GAS SENSING SURVEILLANCE SYSTEM

(71) Applicant: BEAMONICS AB, Lund (SE)

(72) Inventors: Can XU, Lund (SE); Jesper BORGGREN, Lund (SE)

(73) Assignee: BEAMONICS AB, Lund (SE)

(21) Appl. No.: 19/166,719

(22) PCT Filed: Apr. 4, 2024
(86) PCT No.: PCT/SE2024/050313

§ 371 Date: Sep. 18, 2025

(30) Foreign Application Priority Data
Apr. 5, 2023 (SE) 2330152-6

(51) Int. Cl. G01N 21/39; G01N 21/01; G01N 21/25

(52) U.S. Cl. CPC G01N 21/39; G01N 21/01; G01N 21/255; G01N 2021/0112; G01N 2021/399; G01N 2201/0612; G01N 2201/068; G01N 2201/127

(57) ABSTRACT

A gas sensing surveillance system integrates a tuneable diode laser absorption spectroscopy (TDLAS) sensor system with a camera to detect and visualize gas leaks, smoke and particulates. The system is housed in a specially designed housing that protects the TDLAS sensor system from environmental factors and physical damage. The housing also contains power and control systems that coordinate the functioning of both components. An optical window with mechanical actuators and optical-filters is used to reduce optical interference and improve performance. The configuration of the housing to accommodate both the Camera and TDLAS sensor system allows visualization of the presence of gas leaks or particulate and smoke or distances to an area of interest in space. The system can accurately measure gas concentration and improve the sensitivity and specificity of gas leak detection.

### FIELD

This technology relates to the field of gas sensing and surveillance systems.

### BACKGROUND

Gas leaks can have serious consequences, including explosions, fires, and health hazards. Therefore, detection and visualization of gas leaks are essential for public safety. Traditional gas sensors may detect the presence of gas, but they do not provide any visual information about the location or severity of the leak. Therefore, there is a need for a gas detection system that combines gas sensing and imaging capabilities.

Various gas sensing systems have been developed in the past, including Fourier Transform Infrared (FTIR) spectroscopy, Differential Optical Absorption Spectroscopy (DOAS), electrochemical detection, and Laser-Induced Fluorescence (LIF). However, these traditional gas sensing systems have several limitations, such as low sensitivity, directional dependence, and susceptibility to interference from other gases and environmental factors.

In recent years, tunable diode laser absorption spectroscopy (TDLAS) has emerged as a promising technique for gas sensing. TDLAS uses a narrow-band laser beam that is tuned to match the absorption line of the target gas. When the laser beam passes through the gas, a small fraction of the light is absorbed by the gas particles or molecules, and the remaining light is detected by a photodetector. TDLAS has several advantages over traditional gas sensors, such as high sensitivity, selectivity, speed, accuracy and intrinsic remote sensing or stand-off detection capabilities. Furthermore, it is known that distance measures can be simultaneously achieved in TDLAS, for example, through triangulation or through carefully modulating and demodulating the narrowband signal or through modulation and phase-detection schemes.

Another challenge with gas sensing systems is the need for visualization of gas leaks. Traditional methods for gas visualization include infrared cameras. However, these methods may not be effective in certain environments, such as outdoor or industrial areas and require strong IR light sources, whether artificial or natural. The environments which the disclosed systems are employed typically also involve combustible gases or explosion risks or fire hazards. The TDLAS instrument can in these scenarios also provide information on smoke or particulate emissions remotely, to provide the user with an early warning system, whereas traditional remote sensors rely again on the existence of light, whether artificial or natural, for example, to detect the presence of smoke in darkness.

The existing gas sensing systems have several limitations, such as low sensitivity, directional dependence, susceptibility to interference from other gases, cross-talks and sensor poisoning as well as environmental factors. Furthermore, traditional gas visualization methods such as infrared cameras may not be effective in certain environments, such as outdoor or industrial areas. Additionally, the conventional gas sensing systems do not provide any high-quality visual information about the location or severity of the leak. Therefore, there is a need for a gas detection system that combines gas sensing and imaging capabilities in a compact, reliable, and cost-effective manner which can also provide the distance information to the target volume being sensed and presence of elevated smoke or particle levels in the target volume.

### SUMMARY

According to a first aspect of the disclosure, a gas sensing surveillance system is presented that comprises a housing configured to house a camera and a tuneable diode laser absorption spectroscopy (TDLAS) sensor system. The housing comprises an optical window.

Optionally the TDLAS sensor system comprises a light source and a light detector. This configuration allows for the simultaneous monitoring of visual and gas data, providing a comprehensive surveillance solution.

Optionally in some examples, the optical window is made of reinforced glass. This feature enhances the durability of the system, ensuring that it can withstand harsh environmental conditions and potential impacts without compromising its functionality.

Optionally in some examples, the TDLAS sensor system's light source and light detector are separated into different compartments within the housing. This separation can prevent potential interference between the light source and detector, thereby improving the accuracy and reliability of the gas sensing data.

Optionally in some examples, index matching gels are used to attach either the light source or light detector to the optical window. This method of attachment can enhance the optical coupling between the components, improving the efficiency and performance of the system.

Optionally in some examples, the system further comprises hardware subtraction or normalization circuitry to eliminate the effect of direct back-reflection of laser light from the optical window onto the detector. This feature can significantly reduce noise in the system, leading to more accurate and reliable gas sensing data.

Optionally in some examples, the optical window contains ultrasonic transducer actuators, piezomechanical actuators, linear actuators or linear motors used to create a dithering motion to reduce optical interference. This feature can further improve the quality of the gas sensing data by minimizing the impact of optical interference.

Optionally in some examples, the optical window contains bandpass-filters to selectively filter out wavelengths of light emitted by the TDLAS sensor system. This feature can enhance the specificity of the gas sensing data, allowing for the detection and identification of specific gases.

Optionally in some examples, the bandpass-filters are arranged to be used as a separate accessory that can be mounted onto the camera such that they are designed to be easily replaceable. This design allows for the easy and cost-effective replacement of the filters, facilitating the maintenance and longevity of the system.

Optionally in some examples, the bandpass-filters are optimized for specific gas types or mixtures. This feature allows for the targeted detection and identification of specific gases, enhancing the versatility and applicability of the system.

Optionally in some examples, the system further comprises polarizers or lenses. These components can improve the quality of the visual data captured by the camera, enhancing the overall surveillance capabilities of the system.

Optionally in some examples, the system further comprises a distance sensing capability for the TDLAS sensor system. This feature can provide valuable information about the location and spread of detected gases, enhancing the system's ability to monitor and respond to gas-related incidents.

Optionally in some examples, the distance sensing capability is configured to determine the distance and/or position of a detected gas. This feature can provide precise and detailed information about the location of detected gases, facilitating more effective monitoring and response strategies.

Optionally in some examples, the distance sensing capability is achieved through modulated waveforms to the light source. This method can provide accurate and reliable distance data, enhancing the system's ability to monitor and respond to gas-related incidents.

Optionally in some examples, the distance sensing capability is achieved through triangulation using the combined information between the TDLAS sensor system and the camera placed at different positions and angles. This method can provide highly accurate and detailed location data, further enhancing the system's monitoring and response capabilities.

Optionally in some examples, the TDLAS sensor system and/or camera is configured to detect particulate or smoke. This feature expands the system's surveillance capabilities, allowing it to monitor for a wider range of potential hazards.

Optionally in some examples, the output of the camera and the output of the TDLAS sensor system are combined to detect a gas. This feature allows for the correlation of visual and gas data, providing a more comprehensive understanding of the monitored environment and enhancing the system's ability to detect and respond to gas-related incidents.

In a first aspect, the present disclosure is a gas sensing surveillance system that combines a gas-sensing detector with a camera to detect and visualize gas leaks. The system comprises a housing that is configured to house both the camera and the detector, and which contains an optical window to protect the components from external elements. The TDLAS sensor system may include a light source and a light detector, which are separated into different compartments within the housing. The optical window may contain ultrasonic transducers, linear actuators, linear motors, or piezoelectric actuators to create a dithering motion to reduce optical interference and reduce deposition of dust, dirt and water onto the optical windows, and notch-filters, bandpass filters, interference filters, color filters or liquid-crystal based filters to selectively filter out wavelengths of light emitted by the TDLAS sensor system. Optional features include the use of index matching gels to attach either the light source or the light detector to the window, the use of polarizers or lenses to further enhance the performance of the gas leak detection system, and focus mechanisms for directionality and focus steering of the sensor field-of-view, such focus mechanisms could comprise of one or several lens packages coupled to mechanical actuators, MEMS devices, liquid lenses or spatial light modulators. Furthermore, the TDLAS sensor may include hardware and software features which allows it to sense distances and particulate or smoke simultaneously or in sequence with the gas sensing remotely.

### BRIEF DESCRIPTION OF THE DRAWINGS

The disclosure will now be described in more detail with reference to the accompanying drawings, in which:

FIG. 1 is a schematic diagram of the gas sensing surveillance system 10, showing the housing (40) configured to house the Camera (30) and tuneable diode laser absorption spectroscopy (TDLAS) sensor system (20).

FIGS. 2a to 2c show detailed views of the TDLAS sensor system (20), showing the separate compartments for the light source (60) and detector (70), along with the optional index matching gels used to attach the light source 60 to the optical window (50) and the hardware subtraction or normalization circuitry used to eliminate the effect of direct back-reflection of laser light from the optical window 50 onto the detector.

FIG. 3 is a detailed view of the optical window (50), showing the actuator used to create a dithering motion and reduce optical interference, focus mechanisms, as well as the bandpass-filters (100) used to selectively filter out wavelengths of light emitted by the TDLAS sensor system 20.

FIG. 4 shows an example schematic of how the TDLAS sensor system 20 with distance sensing capability operates.

FIG. 5 shows an example of a dichroic mirror used to separate the emitted light from the TLDAS system and incoming light for the camera.

### DETAILED DESCRIPTION

The present disclosure will now be described in detail with reference to example embodiments. It should be understood that these example embodiments are provided for illustrative purposes only and are not intended to limit the scope of the present disclosure.

### Gas Sensing Surveillance System

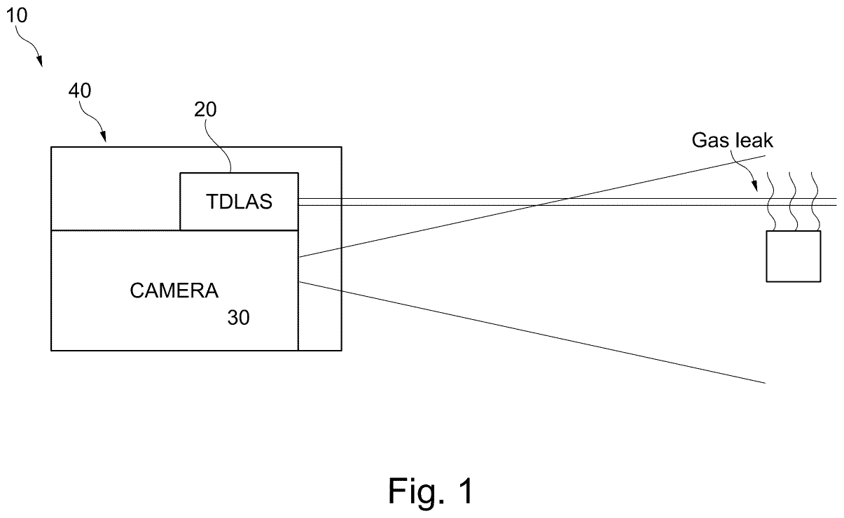

According to an embodiment shown in FIG. 1, the gas sensing surveillance system 10 comprises a housing 40 configured to house both a camera 30 and a tuneable diode laser absorption spectroscopy (TDLAS) sensor system 20. The housing 40 is designed with internal dimensions, supports, and enclosures to secure and protect both components. Additionally, the housing 40 includes power and control systems to regulate and coordinate the functioning of both the Camera 30 and the TDLAS sensor system 20.

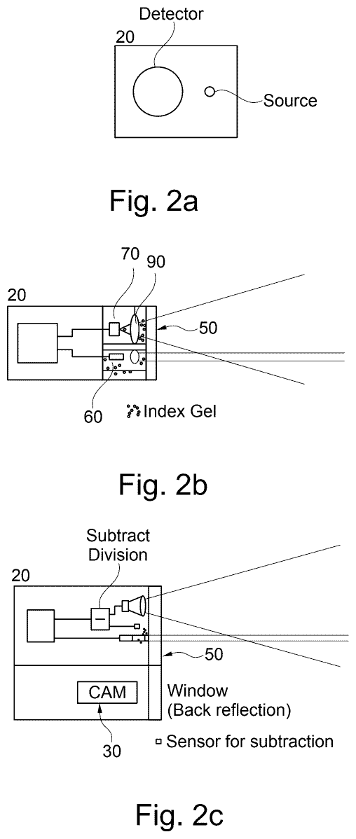

FIG. 2a shows a view of an embodiment of the TDLAS sensor system 20, which includes a light source 60 and a light detector 70. As shown in the embodiment of FIG. 2c, the TDLAS sensor system 20 may be housed in a separate compartment from the Camera 30 to prevent any interference, and the light source 60 is optionally attached to the optical window 50 with index matching gels to guide the laser beam without any loss of energy due to reflection. Alternatively, the light source assembly is optically separated from the detector assembly through mechanical compartments or mechanical beam blocking features to prevent back reflection from the light source onto the detector. Hardware subtraction or normalization circuitry can be used to eliminate the effect of direct back-reflection of laser light from the optical window onto the detector, thus improving the sensitivity and accuracy of the gas leak detection system.

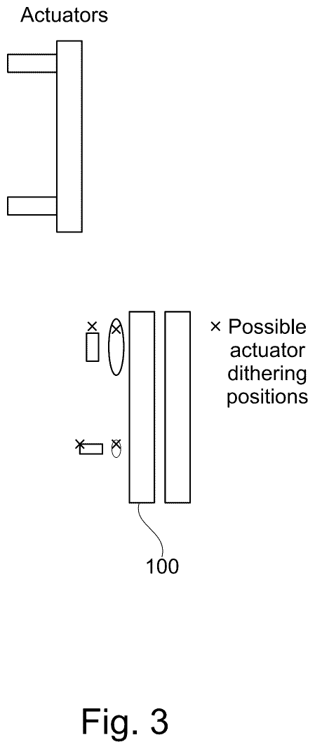

FIG. 3 shows a detailed view of an embodiment of the optical window 50, which includes actuators to create a dithering motion and reduce optical interference. Bandpass-filters 100 are used to selectively filter out wavelengths of light emitted by the TDLAS sensor system 20, reducing any overlap or interference between the two systems. The bandpass-filters 100 may be made of special optical materials with high rejection rates over a range of wavelengths and narrow transmission bandwidths centered around the wavelengths of interest, designed for specific gas types or mixtures, and optimized for different target gases and environments. The bandpass-filters 100 can be integrated into the housing structure, optical dome, optical window or as a separate accessory mounted onto the camera. They can also be combined with other optical components such as polarizers or lenses to improve the performance of the gas leak detection system.

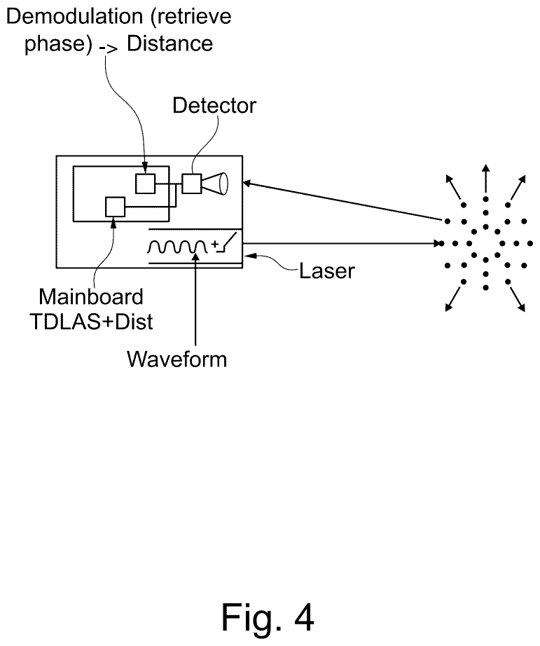

FIG. 4 shows an example schematic of how the TDLAS sensor system 20 with distance sensing capability operates. In this example, the TDLAS sensor system 20 emits a modulated laser beam to a target area, and the light that is absorbed by gas molecules is detected by the light detector 70. The TDLAS sensor system can, using the same light detector, simultaneously determine the gas concentration and the distance of the detected gas plume. At the same time, the environment and gas plume (where visible to the camera) is imaged by a camera. The distance information, gas composition information, and video information are then combined and analyzed to provide information about the localization, size, and shape of the gas plume.

### TDLAS Sensor System

Although the present disclosure discusses the use of a TDLAS sensor system 20, the gas detecting system may be understood to include alternative configurations of gas detecting equipment, including equipment comprising a light source 60 as a tuneable diode laser, a narrowband or broad band multi-mode source, a high-power multimode diode laser, a high-power multimode fibre laser, a high-power tapered amplifier seeded by a tuneable single mode diode laser, a high-power fibre amplifier seeded by a tuneable single mode diode laser, a high-power tuneable CO2 or solid-state crystal laser, or a non-coherent light source. The light detector 70 may be a complementary metal-oxide-semiconductor (CMOS) sensor, a charge-coupled device (CCD) sensor, semiconductor photodiode, p-n junction detectors, avalanche photodiode, photo-multiplying tube detector, pyroelectric detector, or polycrystalline sensor types with a lens arrangement 90. Lens arrangement 90 is configured to focus the light onto the sensor. The lens arrangement 90 may be variable to adjust the focus and enhance the sensitivity of the system. The light detector 70 may further include optical filters or polarizers to increase the contrast and signal-to-noise ratio of the captured images, and to reject unwanted background light. The sensors are configured to send one or more signals to the controller.

The TDLAS sensor system will therefore combine data from the camera 30 with gas content information and optionally distance information of the probed volume(s). In a variation, the TDLAS sensor system could be configured to only supply distance information or to only supply gas content information. In another variation, the TDLAS sensor system could simultaneously also supply the presence of elevated particulate or smoke levels in the probed volume(s).

In this way, the TDLAS sensor system 20 comprises the light source 60 and the light detector 70. The light source 60 and the light detector 70 are both mounted within the housing 40. As mentioned, the light source 60 and the light detector 70 can be mounted in the housing 40 within in the same housing compartment or in separate housing compartments.

### Camera

In some embodiments, the gas sensing surveillance system 10 includes a camera 30. The camera 30 may be selected from a group of cameras comprising a high-resolution RGB camera, a night vision camera, an outdoor weather-resistant camera, a pan-tilt-zoom (PTZ) camera, a wide-angle view camera, an infrared camera, a network-connected camera, and a smart camera with artificial intelligence (Al) capabilities. The camera 30 may provide additional visual information and context to the gas leak detection system. The specific type of camera 30 selected may depend on the particular implementation and requirements of the gas sensing surveillance system 10.

Alternative camera configurations may be thermal imaging cameras, hyperspectral cameras, and multispectral cameras. Thermal imaging cameras can detect temperature differences and IR absorption caused by gas leaks, which can be used to create a visual image of the gas cloud. Hyperspectral cameras can capture detailed spectral information across a wide range of wavelengths, allowing for highly accurate identification of gas leaks based on their unique spectral signatures. Multispectral cameras can capture information across multiple wavelengths, but with lower spectral resolution than hyperspectral cameras, allowing for faster detection and localization of gas leaks in real-time.

### Housing

In some embodiments, the gas leak detection system housing 40 may have a length of 10-30 cm, a width of 10-20 cm, and a height of 10-20 cm. The material used may be non-conductive and non-reactive with a thickness of 0.5-1 cm. The housing 40 may also have at least two openings for maintenance and inspection, with locking mechanisms being optional but recommended for security purposes. The housing 40 is designed to securely hold and enclose the two components, protecting against external elements that can interfere with their function.

The housing 40 may be designed as a protective barrier against external elements, and prevents dust and debris from interfering with the TDLAS sensor system 20, provides impact protection against nearby explosions or blasts resulting from e.g. gas leaks, shields the TDLAS sensor system 20 from extreme temperatures, humidity, moisture, electromagnetic interference (EMI) and radio frequency interference (RFI), reduces the impact of external vibrations or seismic activity, prevents sunlight from interfering with spectral analysis, minimizes the risk of tampering or sabotage, and improves the lifespan and durability of the TDLAS sensor system 20.

The power system and control system in the housing 40 may regulate and coordinate the functioning of both the Camera 30 and TDLAS sensor system 20. The power system may be configured to provide sufficient power to both systems, while the control system may manage the flow of data and control signals between the systems.

### Optical Window

In some embodiments, the gas sensing surveillance system 10 may include an optical window 50 that is particularly sturdy to protect against explosions. The optical window 50 may be made of reinforced glass or polycarbonate material, and may be designed to have a thickness of 1-2 cm. However, using thick optical windows 50 may result in direct back-reflection of the light emitted by the light source 60 onto the detector, saturating the detector or unwanted light-guiding effects.

In some embodiments, the optical window 50 comprises the front lenses of the TDLAS instrument. The front lenses may be particularly sturdy to protect against explosions and environmental factors, and may be designed to have thicknesses of 1-2 cm. Optionally, the optical window 50 may be arranged in front of just one of the light detector 70 or light source 60, with the other optical aperture covered by a front lens.

### Separate Compartments

To overcome this problem, the housing 40 may contain separate compartments for the light source 60 and light detector 70. This can overcome the problem of direct back-reflection. Furthermore, this can prevent interference from other components or external sources. Optionally, the light source could be collimated and contained in a mechanical cylinder with a separate front glass optical window, thus preventing direct feedback onto the light detector 70. Whilst the light source 60 and light detector 70 can be mounted within separate compartments of the housing 40, in other examples the light source 60 and the light detector 70 can be mounted within the same compartment. For example, the light source 60 and the light detector 70 can be mounted within the same compartment, but separated by an internal wall or an internal feature of the housing 40.

### Optical Interference

Using thick optical windows 50 may also result in optical interference from the window influencing spectroscopic performance of the TDLAS sensor system 20. To reduce the effects of optical interference, dithering methods may be used to create a vibration in the optical window 50.

### Dithering Methods

In some embodiments, dithering methods may be employed to minimize optical interference in gas detection systems. The dithering methods can be carried out by the circuitry and controller. To achieve this, ultrasonic transducers may be installed on the optical window 50 to produce vibrations that prevent the accumulation of condensation or ice, which may interfere with gas detection. These transducers may be designed to generate either a vibration or dithering motion that reduces the effects of optical interference, leading to improved spectroscopic performance of the TDLAS sensor system 20. Alternatively, a piezomechanical dithering device may be used, which utilizes actuators commonly found in tactile feedback devices that are compact, high volume, and cost-effective. Alternatively, linear actuators or linear motors may be used to provide a mechanical movement to minimize optical interference and depositions on the optical elements.

### Bandpass Filters

In some embodiments, the gas sensing surveillance system 10 further comprises bandpass-filters 100 placed in front of the camera 30 to enhance the sensitivity and specificity of the gas leak detection system. These bandpass-filters 100 can be specifically designed to selectively filter out the wavelengths of light that are emitted by the TDLAS sensor system 20, reducing any overlap or interference between the two systems. The bandpass-filters 100 can be made of special optical materials with high rejection rates over a range of wavelengths, but narrow transmission bandwidths that are centered around the wavelengths of interest for the TDLAS sensor system 20. Additionally, these filters can be easily replaced or optimized for specific gas types or mixtures, allowing for customization of the system to different target gases and environments. Easily replaceable means that the bandpass-filters 100 can be placed or mounted to the camera 30 or another optical component of the gas sensing surveillance system 10 without the disassembly or assembly of other components of the gas sensing surveillance system 10. For example, the bandpass-filters 100 can be clipped to existing components. Other types of mounting arrangements can be provided e.g. screw fitting, bayonet fitting etc. In some examples, the mounting of the bandpass-filters 100 is a tool-free operation. The bandpass-filters 100 can be integrated into the housing structure, the optical dome, the optical window or used as a separate accessory that can be mounted onto the camera, and can be combined with other optical components or image processing techniques to further enhance the performance of the gas leak detection system.

In some examples, the gas sensing surveillance system 10 optionally comprises a multi-band bandpass filter. A multi-band bandpass filter is a type of filter that allows only certain frequency bands to pass through while attenuating frequencies outside of those bands. It is designed to separate a signal into multiple frequency bands, allowing each band to be processed independently.

In some examples, the multi-band bandpass filter includes a plurality of individual filters that are each tuned to pass a specific frequency band. Each bandpass filter allows only a desired range of frequencies to pass through while blocking out others. The multi-band bandpass filter may comprise a crossover which is used to divide the signal into different frequency bands before it enters the bandpass filters. The crossovers are designed to split the signal into two or more frequency ranges based on frequency response characteristics. The multi-band bandpass filter may also comprise a summing amplifier which is used to combine the outputs of the different bandpass filters. It takes the filtered signals from each bandpass filter and combines them back together to create the final multi-band output.

In addition to separating the compartments, the optical window 50 may include a thin layer of optical black or optically dense material between the glass layers of the sandwiched optical window 50. This can reduce optical interference and improve performance. Further, a cylinder of bonded black glass or substrate may surround the center part (where source light exits) for co-axial alignment of the light source 60 and detector, which can prevent direct back reflection.

The gas sensing surveillance system 10 may further comprise a focus mechanism for directionality and focus steering of the sensor field-of-view. This focus mechanism may comprise one or several lens packages coupled to mechanical actuators, MEMS devices, liquid lenses or spatial light modulators. The focus mechanism may be used to adjust the direction and focus of the gas leak detection system, allowing for targeted detection and localization of gas leaks in specific areas. The focus mechanism can be controlled by the circuitry and the controller, e.g. by the controller sending a control signal to the actuator of the focus mechanism and adjust the focus of the gas sensing surveillance system 10.

Mechanical actuators may include linear or rotary motors or piezoelectric actuators that can move the lens packages or the TDLAS sensor system in a specific direction to adjust the focus of the system. MEMS devices, liquid lenses, or spatial light modulators may use electrical signals to manipulate the shape or position of the lenses, providing a more precise and rapid method of adjusting the focus of the system.

### Index Matching Gels

In an embodiment shown in FIG. 2b, the gas sensing surveillance system 10 may include a feature of attaching the light source 60 or light detector 70 to the optical window 50 using index matching gels. These gels have similar refractive indices to the materials they are in contact with, allowing the laser beam to be guided through the window without any loss of energy due to reflection. This improves the accuracy and sensitivity of the gas leak detection system by directing more of the laser energy towards the target area.

### Hardware Subtraction and Normalization Circuitry

FIG. 2c shows an embodiment in which hardware subtraction or normalization circuitry is used to eliminate the effect of direct back-reflection of laser light from the optical window 50 onto the detector, which can saturate the detector and generate false readings. The circuitry works by including a reference detector in the same compartment as the primary detector. This reference detector detects the amount of light that is directly reflected from the optical window 50 and generates a signal proportional to that amount of light. The signal from the reference detector is then subtracted from the signal of the primary detector or the signal from the reference detector is used to normalize the primary detector signal through, e.g., division, which eliminates the effect of the direct back-reflection component from the gas absorption spectrum and overcomes effects of saturations in the analog and digital electronics before the signal processing steps.

In some examples, the circuitry comprises a controller (not shown) having a processor and an associated memory which is configured to control one or more functions of the TDLAS sensor system 20. For example, the controller is configured to actuate the light source 60 and the light detector 70 during detection of gases. Furthermore, the controller is configured to receive one or more signals from the light detector 70 and process the received sensor signal in order to determine the presence of a gas using the processes, algorithms and method steps as discussed herein. The controller is also configured to control other components of the TDLAS sensor system 20 as required.

### TDLAS Distance Sensing Capability

In some embodiments, the TDLAS sensor system 20 may also have the capability to measure distance of the detected gas either through triangulation or through modulating and demodulating the narrowband signal or through a modulation and phase-detection schemes. This distance sensing capability may be achieved by the use of modulated waveforms to the light source 60. The modulated light can be detected by the detector arrangements and demodulated in hardware or software to retrieve the distance information of the detected light simultaneously with the gas composition. The modulation can be added as a component of the transmitted light, allowing for the simultaneous detection of the gas signal, in direct absorption mode or wavelength modulation spectroscopy mode or frequency modulation spectroscopy mode. Optionally, the distance sensing and gas sensing could be performed in a sequential manner. Optionally, the modulation could be simple on-off or square-wave-like signal and demodulation comprises of identifying the flank delays between the modulated emitted light and modulated received light. The controller is configured to perform the various distance sensing capabilities as discussed herein.

Alternatively, the distance sensing capability can be achieved through triangulation, which involves the use of combined data from either the camera or a separate 1-D or 2-D optical sensor and the TDLAS instrument. By knowing the angle of the light source and the separation between the TDLAS light source and the optical axis of the second sensor and optionally also the depth of focus of the second sensor, it is possible to compute the distance onto a target by creating a distance-to-pixel-number map.

This distance sensing capability can allow the TDLAS sensor system 20 to provide not only gas leak detection but also localization and quantification of the gas leak, as well as the size and shape of the gas plume in three dimensions.

The TDLAS sensor system 20 may also be able to differentiate between multiple gas leaks that may be occurring simultaneously in different locations. This is achieved by using a combination of distance sensing and spectral analysis, which allows the system to identify and distinguish between different gas leaks based on their chemical composition and location.

### Smoke-Detection

In one embodiment, the TDLAS system of the present disclosure is configured to simultaneously detect and provide information on the presence of elevated particulate levels or smoke in the probed volume(s) along with gas and distance information. This can be achieved by the controller analyzing the scattering and absorption properties of the transmitted and received laser light. The presence of particulates or smoke in the probed volume can cause changes in the intensity and spectral characteristics of the received light, which can then be used to identify the presence of smoke or elevated particulate levels. Similarly, the camera 30 may be able to resolve and detect smoke depending on environmental lighting and camera type.

The ability to detect smoke or elevated particulate levels can provide an early warning system for potential fire hazards, allowing for timely intervention and prevention of further damage or risk. Additionally, this information can be combined with the gas leak detection data to provide a comprehensive assessment of the environment, helping to identify potential hazards and ensure public safety.

### Dichroic Mirror

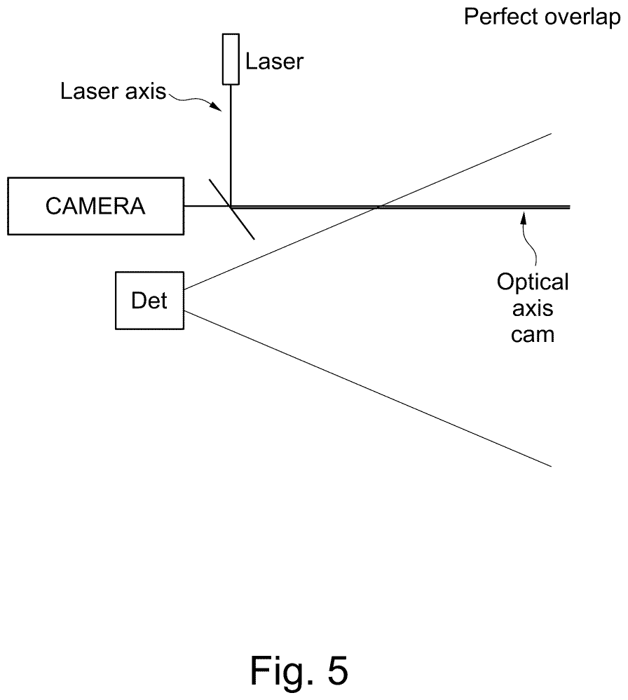

In one embodiment shown in FIG. 5, a dichroic mirror is used to separate the emitted light from the TLDAS system and incoming light for the camera. The dichroic mirror is an optical filter that reflects certain wavelengths of light while transmitting others, and can be used to separate the spectral bands of interest for both systems. The dichroic mirror may be positioned at a specific angle with respect to the camera, to overlap the optical axis of the TDLAS system with the optical axis of the camera, and configured for the desired wavelengths to ensure optimal transmission for the light to the camera, whilst allowing the light from the TLDAS light source to be reflection towards the gas to be detected. Example wavelengths for transmission to the camera may include visible or infrared light, while the wavelengths for reflection may be specific to the gas being detected, e.g., around 1650 nm for methane detection or 760 nm for oxygen detection. This allows for simultaneous detection of both gas content and visual information, with reduced interference or overlap between the two systems and no parallax effects, since the TDLAS light source is narrow band and will not create distortion in the imaged spectral-region(s) for the camera.

In some examples, the TDLAS sensor system 20 is configured to sense multiple gases. In this way, the TDLAS sensor system 20 can use a single light source 60 and a single light detector 70 to detect different gases. In some examples, the light source 60 and the light detector 70 can be tuned to a predetermined response frequency depending on the particular gases that are to be detected. The controller is configured to adjust the configuration of the light source 60 and/or the light detector 70 in dependence on the required gas to be detected.

In some examples, the TDLAS sensor system 20 comprises a temperature sensor to detect the ambient temperature of the TDLAS sensor system 20. The temperature sensor is configured to send a sensor signal to the controller. In response to the received temperature the controller can determine the operating parameters of the TDLAS sensor system 20. In some examples, the controller can send one or more control signals to adjust the operation of the TDLAS sensor system 20 as needed. For example, if the controller determines that the TDLAS sensor system 20 is operating outside a preferred temperature range, the controller can send a control signal to deactivate the TDLAS sensor system 20 until the TDLAS sensor system 20 has cooled down. Additionally, or alternatively, the controller can send a control signal to a cooling mechanism to actively cool the TDLAS sensor system 20. For example, the cooling mechanism can comprise a motor fan assembly which creates an airflow through the TDLAS sensor system 20. The cooling mechanism can be any suitable arrangement for cooling the TDLAS sensor system 20. In some examples, the cooling mechanism can be a water-cooled system. In some examples, the cooling mechanism e.g. a fan, is always on, but the controller can issue control signals to determine the speed that the fan spins. In this way, the controller can adjust the airflow and the rate of cooling of the TDLAS sensor system 20.

Furthermore, in some examples, the controller is configured to determine the external temperature based on the gas signature profile. In other words, the controller is able to estimate the external temperature in the vicinity of the gas based on the analysed data received from the light detector 70. This increases the precision and accuracy of the analysed results.

In some examples, the controller may be configured to correlating gas signatures with known temperature patterns. For example, the controller is configured to analyse historical data of gas signatures and corresponding external temperatures. In this way the controller can establish a correlation between the two variables and the controller stores the correlation in the memory. The controller uses the correlation to predict external temperatures based on the current gas signature profile.

Additionally, or alternatively, the controller is configured to use mathematical models to predict the external temperature. These models could be based on principles of thermodynamics, heat transfer, and gas behaviour to estimate temperatures.

Additionally, or alternatively, the controller is configured to use machine learning algorithms. The controller is configured to train the algorithm to predict temperatures based on gas profiles. The algorithm would learn the patterns and relationships between the two variables and provide accurate temperature estimates.

Additionally, or alternatively, the controller is configured to use a calibration process with one or more external temperature sensors. The controller performs the calibration with the external temperature sensors to establish a direct relationship between gas signatures and temperatures. This calibration would allow for real-time monitoring and adjustment of temperature estimates based on the gas profile.

In some examples, the controller is configured to perform an automatic gain control (AGC) function with the light detector 70. The controller is configured to adjust the gain of the signal to ensure optimal signal quality. In some examples, the controller automatically adjusts the gain of the system in real-time to maintain a constant output level, despite changes in input signal strength.

The controller may optionally comprise an analog-to-digital converter (ADC). The ADC is configured to convert the analog signal received from the detector into a digital format that can be processed by the system. The controller may further comprise a gain control amplifier which is configured to adjust the gain of the system based on the input signal strength. The gain control amplifier receives feedback from the system to determine the appropriate gain level needed to maintain a constant output level.

The controller is then configured to apply signal processing to the digital signal received from the ADC and applies the gain adjustment determined by the gain control amplifier.

When the controller performs automatic gain control function together with the light detector 70 the controller continuously monitors the input signal strength and dynamically adjusts the gain of the system to maximize signal quality. This allows the system to maintain a stable output level, even in the presence of noise or signal variations.

In a single sweep or ramp of the detector, the controller carrying out the AGC function can quickly adjust the gain to optimize signal quality, without the need for manual intervention. This real-time adjustment ensures that the detector operates effectively in various signal conditions, providing accurate and reliable measurements.

### EXAMPLES

### Example 1

A gas sensing surveillance system comprising a housing configured to house a camera and a tuneable diode laser absorption spectroscopy (TDLAS) sensor system, wherein the housing comprises an optical window and wherein the TDLAS sensor system comprises a light source and a light detector.

### Example 2

The gas sensing surveillance system of example 1, wherein the optical window is made of reinforced glass.

### Example 3

The gas sensing surveillance system of example 1 or 2, wherein the TDLAS sensor system comprises a light source and a light detector separated into different compartments within the housing.

### Example 4

The gas sensing surveillance system of any of examples 1 to 3, wherein index matching gels are used to attach either the light source or light detector to the optical window.

### Example 5

The gas sensing surveillance system of any of examples 1 to 4, further comprising hardware subtraction or normalization circuitry to eliminate the effect of direct back-reflection of laser light from the optical window onto the detector.

### Example 6

The gas sensing surveillance system of any of examples 1 to 5, wherein the optical window contains ultrasonic transducer actuators, piezomechanical actuators, linear actuators, or linear motors used to create a dithering motion to reduce optical interference.

### Example 7

The gas sensing surveillance system of any of examples 1 to 6, wherein the optical window contains bandpass-filters to selectively filter out wavelengths of light emitted by the TDLAS sensor system.

### Example 8

The gas sensing surveillance system of example 7, wherein the bandpass-filters are arranged to be used as a separate accessory that can be mounted onto the camera such that they are designed to be easily replaceable.

### Example 9

The gas sensing surveillance system of example 7 or 8, wherein the bandpass-filters are optimized for specific gas types or mixtures.

### Example 10

The gas sensing surveillance system of example 7, 8, or 9, further comprising polarizers or lenses.

### Example 11

The gas sensing surveillance system of any of examples 1 to 10, further comprising a distance sensing capability for the TDLAS sensor system.

### Example 12

The gas sensing surveillance system of example 11, wherein the distance sensing capability is configured to determine the distance and/or position of a detected gas.

### Example 13

The gas sensing surveillance system of example 11 or 12, wherein the distance sensing capability is achieved through modulated waveforms to the light source.

### Example 14

The gas sensing surveillance system of example 11 or 12, wherein the distance sensing capability is achieved through triangulation using the combined information between the TDLAS sensor system and the camera placed at different positions and angles.

### Example 15

The gas sensing surveillance system of any of examples 1 to 14, further comprising the TDLAS sensor system and/or camera configured to detect particulate or smoke.

### Example 16

The gas sensing surveillance system of any of examples 1 to 15, wherein the output of the camera and the output of the TDLAS sensor system are combined to detect a gas.

1. A gas sensing surveillance system comprising a housing configured to house a camera and a tunable diode laser absorption spectroscopy sensor system, wherein the housing comprises an optical window and wherein the tunable diode laser absorption spectroscopy sensor system comprises a light source and a light detector.

2. The gas sensing surveillance system of claim 1, wherein the optical window is made of reinforced glass.

3. The gas sensing surveillance system of claim 1, wherein the light source and a light detector are separated into different compartments within the housing.

4. The gas sensing surveillance system of claim 1, wherein the tunable diode laser absorption spectroscopy sensor system comprises a light source and a light detector and wherein index matching gels are used to attach either the light source or light detector to the optical window.

5. The gas sensing surveillance system of claim 1, further comprising hardware subtraction or normalization circuitry to eliminate an effect of direct back-reflection of laser light from the optical window onto the light detector.

6. The gas sensing surveillance system of claim 1, wherein the optical window contains ultrasonic transducer actuators, piezomechanical actuators, linear actuators or linear motors used to create a dithering motion to reduce optical interference.

7. The gas sensing surveillance system of claim 1, wherein the optical window contains bandpass-filters to selectively filter out wavelengths of light emitted by the tunable diode laser absorption spectroscopy sensor system.

8. The gas sensing surveillance system of claim 7, wherein the bandpass-filters are arranged to be used as a separate accessory that can be mounted onto the camera such that they are replaceable.

9. The gas sensing surveillance system of claim 7, wherein the bandpass-filters are optimized for specific gas types or mixtures.

10. The gas sensing surveillance system of claim 7, further comprising polarizers or lenses.

11. The gas sensing surveillance system of claim 1, further comprising a distance sensing capability for the tunable diode laser absorption spectroscopy sensor system.

12. The gas sensing surveillance system of claim 11, wherein the distance sensing capability is configured to determine a distance and/or position of a detected gas.

13. The gas sensing surveillance system of claim 11, wherein the distance sensing capability is achieved through modulated waveforms to the light source.

14. The gas sensing surveillance system of claim 11, wherein the distance sensing capability is achieved through triangulation using combined information between the tunable diode laser absorption spectroscopy sensor system and the camera placed at different positions and angles.

15. The gas sensing surveillance system of claim 1, further comprising the tunable diode laser absorption spectroscopy sensor system and/or camera configured to detect particulate or smoke.

16. The gas sensing surveillance system of claim 1, wherein an output of camera and an output of tuneable diode laser absorption spectroscopy sensor system are combined to detect a gas.
